(19) United States
(12) Patent Application Publication
(10) Pub. No.: US 2006/0249710 A1
(43) Pub. Date: Nov. 9, 2006

(54) Water modifier

(76) Inventor: Ryuichi Suzuki, Yamagata (JP)

Correspondence Address: THE WEBB LAW FIRM, P.C., 700 KOPPERS BUILDING, 436 SEVENTH AVENUE, PITTSBURGH, PA, 15219, US

(21) Appl. No.: 10/537,059

(22) PCT Filed: Mar. 8, 2005
(86) PCT No.: PCT/JP05/03953

§ 371 Date: Jun. 2, 2005

(51) Int. Cl. H01B 1/12

(52) U.S. Cl. 252/500

(57) ABSTRACT

The present invention relates to water modifier for improvement in the characteristics of water and has been made such as for improvement of the fuel consumption of an automobile or giving a good function to the human body, based on a new conception of modifying water itself, which water is capable of being associated with the combustion efficiency, such as water stored in a radiator or water in the form of water vapor contained in air which is mixed with gasoline for combustion, without the necessity to modify an engine or electric system or the necessity to add something to lubricant or the like. It is an object of the present invention to provide water modifier that is capable of contributing to the improvement of fuel consumption of an automobile and giving a function, which desirably affects to the human body, to water, by modifying water per se. Water modifier according to the present invention includes fired earthy substance that contains at least one of Al₂O₃, B₂O₃, BaO, CaO, Fe₂O₃, K₂O, MgO, MnO, Na₂O, SiO₂, TiO₂ and ZnO.

### FIELD OF THE INVENTION

The present invention relates to water modifier and more particularly water modifier for modifying the characteristics of water such as for improving fuel consumption of an automobile or giving a good function to the human body.

### BACKGROUND ART

Various studies have been conventionally made on the utilization of modified water in various applications, while various patent applications were filed. For example, Patent Reference 1 as listed below discloses an invention relating to water modifier formed by placing catechin, saponin or tannin along with ceramics in resin. In this Patent Reference 1, the effect was confirmed by testings, and the object of the invention of Patent Reference 1 is to keep its performance as domestic and industrial water modifier and the effect confirmed by the testings reveals only a conventional effect of functional water such as water having deodorizing function, antimicrobial function, dechlorination function, halomethane-removing function or antioxidation function.

Further, Patent Reference 2 as listed below discloses an invention relating to functional water formed by preparing, as subject liquid, water solution with carbinol having carbon numbers of 2-4 mixed in water having been subjected to treatment under strong magnetic field, and breaking down water molecule clusters of the subject liquid and then fusing them together for the purpose of giving high permeability with aiming at applicability to industrial medicines, pharmaceutical preparations and the like. However, this permeability is given by the mixture of a substantial amount of carbinol to water, and therefore even it is called as functional water, it is not necessary meant that the function of water itself has been improved.

An invention disclosed in Patent Reference 3 relates to a method of producing “far-infrared, hado-water (bio aqua water)” that is transcriptable and exhibits the characteristics and functions of faint energy of far-infrared radiation by, in the presence of photocatalyst, adding light-catalyzed water to raw solution and irradiating ultraviolet rays. However, in the Patent Reference 3, while it is disclosed an effect useful for various disorders such as stiffness of neck, rheumatism and atopic dermatitis thanks to the functions of far-infrared radiation and negative ions that activate cells of the human body and activate the metabolism, an effect of reducing harmful components of exhaust gas of an automobile and an effect of improving the fuel consumption and torque of an automobile by merely coating to the outside mechanism. However, there is disclosed no objective support on these effects such as by testings. Not only this Patent Reference 3 but also many other patent applications relating to water modification disclose merely a conception.

In either case, conventionally, there are no patent applications that disclose the essential modification of water itself objectively supported by the result of testings or the like. Even where such objective testing results are presented, it discloses only the testing results in light of mainly water purification, such as deodorizing function, dechlorination function and antioxidation function, while not disclosing the modification of the function of water itself, as disclosed in the Patent Reference 1.

On the other hand, various studies have been made to develop a technique of improving the fuel consumption of an automobile. For example, an invention disclosed in Patent Reference 4 as listed below relates to an additive agent for lubricant, which contains at least one of polytetrafluoroethylene and boron nitride, and ceramics. This is however exclusively to prolong the life of the lubricant.

An invention disclosed in Patent Reference 5 relates to a technique of improving the performance of a fuel modifier by forming grooves in an outer circumference of a tubular mold member made of such as plastic or ceramics, mounting permanent magnets in the grooves, generating static electricity between fuel and a fuel passage, thereby electrostatically charging the fuel, and then generating a magnetic field so as to allow for generation of static electricity and magnetic treatment in the same place. However, although such a proposal to improve the combustion efficiency of gasoline by the effect of such as static electricity and magnetic field was made before an application of the Patent Reference 5 was filed, the effectiveness thereof is not clear. A device of the Patent Reference 5 was conceived aiming at reducing the size of the device than a conventional device, but it might be difficult to fabricate an instrument made of the tubular mold member, which involves such as forming the grooves and mounting the permanent magnets therein.

An invention disclosed in Patent Reference 6 relates to a technique of improving the combustion efficiency by bonding ceramic powder, which emits weak electromagnetic waves and generates negative ions, and plate-like soft foam or fibrous member to an aluminium adhesive tape via adhesive, which is in turn mounted to an air intake duct or a feed oil pipe. However, the Patent Reference 6 does not objectively support the effect by testings or the like. Not only this Patent Reference 6 but also many other patent applications relating to an automobile fuel combustion efficiency technique disclose merely a conception, in the same manner as the aforesaid water modification.
Patent Reference 1: Official Gazette of Japanese Patent Application Laid-open No. 2001-79567
Patent Reference 2: Official Gazette of Japanese Patent Application Laid-open No. 2002-338940
Patent Reference 3: Pamphlet of WO2002/081383
Patent Reference 4: Official Gazette of Japanese Patent Application Laid-open No. 2004-18555
Patent Reference 5: Official Gazette of Japanese Patent Application Laid-open No. 2003-214266
Patent Reference 6: Official Gazette of Japanese Patent Application Laid-open No. 2003-148708

### DISCLOSURE OF THE INVENTION

### Objects to be Achieved by the Invention

The present invention has been made for improvement of the fuel consumption of an automobile or the like, based on a new conception of modifying water itself, which is capable of being associated with the combustion efficiency, such as water stored in a radiator or water as water vapor contained in air which is mixed with gasoline for combustion, without the necessity to modify an engine or electric system or the necessity to add something to lubricant or the like. It is an object of the present invention to provide water modifier that is capable of contributing to the improvement of fuel consumption of an automobile and giving a function, which desirably affects to the human body, to water, by modifying water per se.

### Means to Achieve the Objects

In order to achieve the above objects, according to the present invention, there is provided water modifier comprising fired earthy substance that contains at least one of Al₂O₃, B₂O₃, BaO, CaO, Fe₂O₃, K₂O, MgO, MnO, Na₂O, SiO₂, TiO₂ and ZnO.

According to the present invention, there is also provided water modifier comprising earthy substance that contains aluminium, boron, barium, calcium, iron, kalium, magnesium, manganese, sodium, silicon, titanium or zinc, or a compound containing these elements in an unfired state, and contains at least one of Al₂O₃, B₂O₃, BaO, CaO, Fe₂O₃, K₂O, MgO, MnO, Na₂O, SiO₂, TiO₂ and ZnO in a fired state. That is, it is not necessary that earthy substance contains as components all of aluminium, boron, barium, calcium, iron, kalium, magnesium, manganese, sodium, silicon, titanium or zinc, or all of an aluminium compound, a boron compound, a barium compound, a calcium compound, an iron compound, a kalium compound, a magnesium compound, a manganese compound, a sodium compound, a silicon compound, a titanium compound or a zinc compound in the unfired state, and therefore earthy substance needs only to optionally contain some of them. Resultingly, the earthy substance contains at least one of Al₂O₃, B₂O₃, BaO, CaO, Fe₂O₃, K₂O, MgO, MnO, Na₂O, SiO₂, TiO₂ and ZnO in the fired state. By a compound containing these elements is meant to also include an oxide of metal or the like. Therefore, it is possible that the earthy substance contains in the unfired state at least one of Al₂O₃, B₂O₃, BaO, CaO, Fe₂O₃, K₂O, MgO, MnO, Na₂O, SiO₂, TiO₂ and ZnO, which are contained after the earthy substance has been fired.

According to the present invention, there is also provided water modifier comprising fired earthy substance that contains 5-20 wt. % of aluminium (Al), 0.05-0.5 wt. % of boron (B), 0.01-0.1 wt. % of barium (Ba), 0.5-3 wt. % of calcium (Ca), 1-5 wt. % of iron (Fe), 0.5-3 wt. % of kalium (K), 0.1-1 wt. % of magnesium (Mg), 0.01-0.1 wt. % of manganese (Mn), 0.1-1 wt. % of sodium (Na), 20-50 wt. % of silicon (Si), 0.05-0.5 wt. % of titanium (Ti) and 0.005-0.05 wt. % of zinc (Zn) according to quantitative analysis by high-frequency inductively coupled plasma emission spectrometry (ICP).

According to the present invention, there is also provided modified water obtained by the treatment with any one of the above water modifiers. By modified water obtained by the treatment with any one of the above water modifiers is meant modified water obtained such as by making water through any one of the above water modifiers. By making water flow through any one of the above water modifiers is meant to obtain the above modified water such as by placing any one of the above water modifiers on a filter and making water through the filter, thereby allowing the water to pass therethrough.

According to the present invention, there is also provided coolant obtained by mixing any of the above modified water with antifreeze. This coolant contains such as 1-50% of modified water and 50-99% of antifreeze. Further, according to the present invention, there is provided a method of producing coolant by mixing any of the above modified water with antifreeze. In this method of producing coolant, it is possible to mix any of the above modified water with antifreeze and then make the mixture flow again through any one of the above water modifiers.

### Effects of the Invention

Water modified by any one of the above water modifiers of the present invention has energy change in water molecule as apparent from the test results mentioned later and is given functionality such as by activation of water molecules. Therefore, it is possible to improve the fuel consumption of an automobile by attaching the water modifier, which may be provided in a chip-like member, to a portion near a radiator of the automobile, or mixing water modified by the water modifier with coolant within a radiator.

A more specific description will be made for the above. It is known that while a proper temperature of water in a radiator is generally within the range of 80-90° C., the fuel consumption efficiency decreases as the temperature rises every 1° C. after exceeding 90° C. Even at 80° C. or below, the fuel consumption efficiency is said to decrease. Water modified by the water modifier of the present invention rapidly emits or absorbs heat thanks to the activation of water molecules, so that by having the water modifier attached to a portion near a radiator, or mixing water modified by the water modifier with coolant of a radiator, water in the radiator is allowed to reach a proper temperature by the effect of heat radiation and heat absorption in a more rapid manner, and therefore excessive energy loss for temperature increase can be saved, hence achieving less fuel consumption loss.

On the other hand, water contained in air is also activated so that the gasoline combustion, which involves the mixture of gasoline with air, is easy to occur by the activation of water molecules, and therefore a better combustion efficiency of gasoline can be achieved. The synergistic action of water produces a better effect in fuel consumption of an automobile than ever.

It was also found an effect of giving a good influence to the human body such as facilitating biological fluid circulation, improving biological defense function and bringing autonomic nerves in a good condition by designing water modified by the water modifier of the present invention as drink water.

### BRIEF DESCRIPTION OF THE DRAWINGS

FIG. 1 is a plan view of a metal chip as one embodiment provided with water modifier.

FIG. 2 is a cross sectional view taken along a line A-A in FIG. 1.

FIG. 3 is a graph with overwritten infrared absorption spectra of modified water and unmodified water of the first measurement.

FIG. 4 is a graph illustrating the difference spectrum between the modified water and the unmodified water of the first measurement.

FIG. 5 is a graph with overwritten infrared absorption spectra of the modified water and the unmodified water of the second measurement.

FIG. 6 is a graph illustrating the difference spectrum between the modified water and the unmodified water of the second measurement.

FIG. 7 is a graph with the difference spectra of FIGS. 4 and 6 overwritten each other.

FIG. 8 is a graph with terahertz absorption spectra of modified water and unmodified water overwritten each other.

FIG. 9 is a graph with average terahertz absorption spectra measured second times, which are overwritten each other.

FIG. 10 is a graph illustrating the difference spectrum between modified water and unmodified water determined from FIG. 9.

FIG. 11 is a schematic view illustrating an attaching state of electrodes for AMI measurement.

FIG. 12 is a schematic view illustrating an ion corrected state in the epidermis and the dermis for explanation of the principle of the AMI measurement.

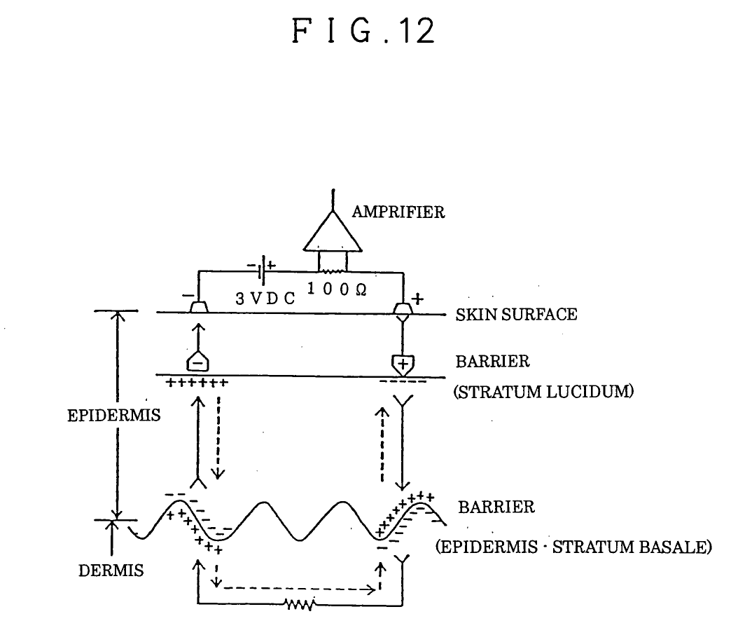

FIG. 13 is a graph illustrating current waveform in the AMI measurement.

### DESCRIPTION OF THE NUMERICAL CODES

1: metal chip

3: powder

### BEST MODE FOR CARRYING OUT THE INVENTION

Hereinafter, the description will be made for embodiments of the present invention.

### Embodiment 1

The composition of water modifier of this embodiment is as follows:

| Component | Weight Ratio (Wt. %) |
|---|---|
| Al₂O₃ | 18.7 |
| B₂O₃ | 0.23 |
| BaO | 0.06 |
| CaO | 1.32 |
| Fe₂O₃ | 3.55 |
| K₂O | 2.21 |
| MgO | 0.56 |
| MnO | 0.05 |
| Na₂O | 1.14 |
| SiO₂ | 69.6 |
| TiO₂ | 0.52 |
| ZnO | 0.02 |

The water modifier of this embodiment is of particulate material (powder substance), made by firing at about 600° C. earthy substance obtained from the soil of a land, where such as medical plants grow, of a mountainous area at attitudes of 500-1000 m in Uenoyama-shi, Yamagata-ken.

### Embodiment 2

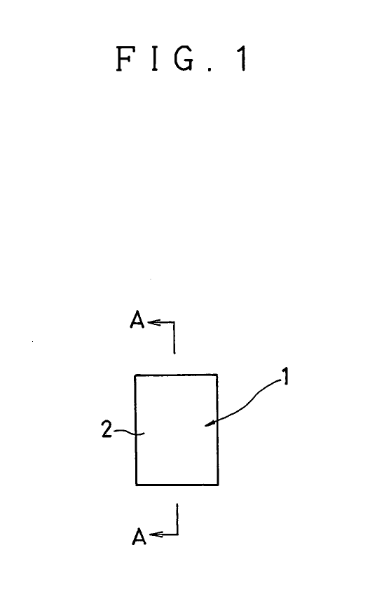

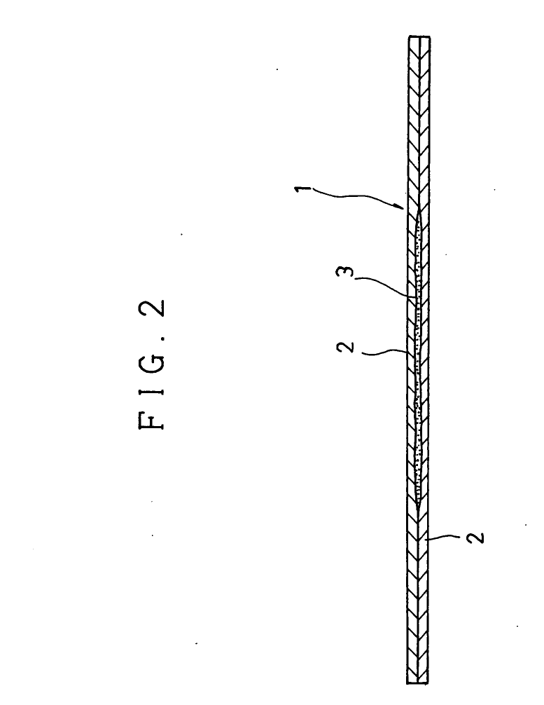

The water modifier having the above composition is used by being embedded in a metal chip 1. Specifically, as illustrated in FIGS. 1 and 2, powder substance 3 of the water modifier is held between two metal pieces 2, 2 and pressed through the metal pieces 2, 2, thereby producing the metal chip 1 with the powder substance 3 of the water modifier embedded therein. The thus produced metal chip 1 is used by being bonded to such as a body part or an upper hose of a radiator of an automobile. By the attachment of the metal chip 1 with the water modifier therein, it is possible to prevent excessive consumption of gasoline and significantly improve the fuel consumption to a degree which has never been achieved.

The above will be hereinafter described in more detail. A proper temperature of water within a radiator is generally within the range of 80-90° C., and the fuel consumption efficiency is decreased as the temperature rises every 1° C. after exceeding 90° C. Even at 80° C. or below, the fuel consumption efficiency is decreased. In this regard, by the attachment of the water modifier in the proximity of a radiator, molecules of water within the radiator can be activated, which activation allows for rapid heat emission and rapid heat absorption. Whereby, water within a radiator can rapidly reach a proper temperature, which allows for saving of excessive energy loss for temperature increase and less fuel consumption loss. In addition, water contained in air has also molecules activated so that combustion of gasoline by the mixture of gasoline and air can be easy to occur and therefore a good combustion efficiency of gasoline can be achieved.

### Embodiment 3

The water modifier can be used for modification of water to be placed in a radiator, as well as being used by being directly attached to a body part of a radiator as described above. According to an example of a method of producing modified water to be placed in a radiator by using the above water modifier, a filter is installed in a container; water modifier of the powder substance is placed on the filter; water with chlorine or the like optionally removed is then placed in the container and then is allowed to flow through the water modifier and pass through the filter.

Water obtained by such filtration has molecules activated as modified water in the same manner as the above, and therefore heat emission and absorption can be promptly carried out. Thus, the thus modified water in a radiator can instantly reach a proper temperature in the range of 80-90° C. On the other hand, after reaching a proper temperature, water is unlikely to be unintentionally raised to 90° C. or higher. This allows water to be kept in a proper temperature range and therefore achieves less fuel consumption loss.

### Embodiment 4

While it is possible to use water, which has passed through the filter with the water modifier thereon, as modified water by placing the same in a radiator without any further processing, it is also possible to previously mix the filtered water with antifreeze, thereby preparing coolant, which is then placed in a radiator.

According to one example of a method of producing the above coolant, water, which has passed through the filter with the water modifier thereon, is left for two days and then mixed with antifreeze. The mixture of the water and the antifreeze is allowed to again pass through the filter with the water modifier thereon and then left for another two days. Then, the mixture is placed in a different container and agitated for four hours. The agitated mixture is then left for another two days. Thus, the coolant to be placed in a radiator is produced.

As antifreeze, it is possible to optionally use alcohols, glycerine or ethylene glycol antifreeze, or other commercially available antifreeze. While it is not necessarily limit the mixing ratio of filtered water and antifreeze to a specific ratio, the mixing ratio with 60% of antifreeze and 40% of filtered water is used as an example of this embodiment.

### Embodiment 5

In this embodiment, the water modifier as described above is used not for the improvement of fuel consumption of an automobile or the like described in the Embodiments 2-4, but for drinking purpose. For example, water modifier having the composition of the Embodiment 1 is embedded in a metal chip as employed in the Embodiment 2, and then a glass with water previously placed therein is placed on the metal chip with the water modifier embedded therein.

Under the above circumstance, they are left for a certain period such as two days. Thus, drinkable modified water can be produced. The modified water thus produced can be served as drinking water, which can work on the human body such as facilitate biological fluid circulation, improve biological defense function and bring autonomic nerves in a good condition. These effects will be described in detail in the following embodiment.

The drinkable modified water can also be produced by placing the water modifier of the Embodiment 1 on a filter installed in a container, and allowing water to flow through the water modifier and then pass through the filter by employing the method of the Embodiment 3.

### Other Embodiments

While a fired product of earthy substance having the above composition and weight ratio is used as water modifier in the above Embodiment 1, it is not necessary to limit the weight ratio of the water modifier to the weight ratio of the above Embodiment. It is essential that water modifier is made of fired earthy substance that contains at least one of Al₂O₃, B₂O₃, BaO, CaO, Fe₂O₃, K₂O, MgO, MnO, Na₂O, SiO₂, TiO₂ and ZnO, or a fired product of earthy substance that contains aluminium, boron, barium, calcium, iron, kalium, magnesium, manganese, sodium, silicon, titanium or zinc, or a compound containing these elements in an unfired state, and contains at least one of Al₂O₃, B₂O₃, BaO, CaO, Fe₂O₃, K₂O, MgO, MnO, Na₂O, SiO₂, TiO₂ and ZnO in a fired state.

As long as the above conditions are met, it is possible contain minimum amounts of other elements or compositions.

However, in light of the effect of causing activation of water molecules as described above, water modifier preferably contains the respective elements or compounds so as to have such as 5-20 wt. % of Al, 0.05-0.5 wt. % of B, 0.01-0.1 wt. % of Ba, 0.5-3 wt. % of Ca, 1-5 wt. % of Fe, 0.5-3 wt. % of K, 0.1-1 wt. % of Mg, 0.01-0.1 wt. % of Mn, 0.1-1 wt. % of Na, 20-50 wt. % of Si, 0.05-0.5 wt. % of Ti and 0.005-0.05 wt. % of Zn according to qualitative analysis by high-frequency inductively coupled plasma emission spectrometry (ICP).

The numerical values of the weight ratio presented in the above embodiment are those in terms of oxide of values determined by the qualitative analysis that will be described hereinafter. Taking into account permissible analyzing test errors, it is assumed that the same functions and effects described in the above embodiments can be produced, as long as qualitative analysis values are within the above ranges.

While the description was made for the Embodiment 2 by taking for example a case where water modifier is embedded in a metal chip for use, a specific form of use of water modifier is not limited to the above Embodiment. For example, it is possible to have water modifier held between ceramic plate members for use. Or, it is possible to have the water modifier placed in a small container of metal or ceramic, which container is then attached to a portion near a radiator. However, it is preferable to employ any form or shape of a member, by which water modifier is easy to be attached to a portion near a radiator.

It is possible to use solely water modifier without being incorporated with any other member such as metal member. In this case, water modifier in the form of powder may be able to be used as it is, but surely can be used such as by molding it into a desired shape.

In the Embodiment 3, water, which has been placed in a container with a filter installed therein and water modifier placed on the filter, flown through the water modifier and passed through the filter, is used as modified water. The method of producing modified water is not limited to this embodiment.

For example, as modified water, it is possible to use water that is produced by first filling water modifier in a bag of a permeable material such as nonwoven fabric or synthetic fibers, placing the water modifier filled bag in a container, introducing water into the container, thus allowing the filled bag to be immersed in water, then leaving the same with keeping this condition for a certain period and then taking the filled bag out of the container, thus using the water left in the container as modified water.

In the Embodiment 4, water passed through the filter with the water modifier thereon is left for two days and then the filtered water is mixed with antifreeze; the mixture of water and antifreeze is allowed to again pass through the filter with the water modifier thereon and then left for another two days; the mixture then is agitated and left for another two days, thereby producing coolant to be placed in a radiator. The method of producing coolant is not necessarily limited to this embodiment. For example, it is possible to skip the step of leaving for two days or the step of agitation. In this case, the mixture of filtered water and antifreeze can be instantly used as coolant. However, it is preferable to make the mixture pass again through the filter with the water modifier thereon for better functions and effects of modified water.

While it is not necessary to limit the firing temperature of earthy substance of water modifier to 600° C. of the Embodiment 1, it is preferable to set it within the range of about 400-700° C.

While the composition of the coolant of the Embodiment 4 comprises 60% of antifreeze and 40% of filtered water (modified water) which passed through the water modifier, it is not necessary to limit the composition of the coolant to a specific composition. However, it is preferable to mix antifreeze and modified water to be respectively in the range of 40-80% and in the range of 20-60%.

The thus produced coolant can be placed in a radiator when in use, but it is also possible to add a small amount of coolant of the present invention to coolant originally placed in a radiator when in use. It is also possible to add the modified water to coolant originally placed in a radiator when in use.

Where water modifier of the present invention is used for improvement of fuel consumption, it is mainly attached to a portion near a radiator or placed in a radiator when in use as in the above embodiments. The attaching position is not necessarily limited to the above embodiments.

Further, in the above embodiments, the description was made for the case where the improvement of the fuel consumption by water modifier of the present invention is for an automobile. However, water modifier of the present invention for this purpose is applicable not only to an automobile, but also a cooling device of an internal combustion engine of a ship, an airplane or a power plant. Or, water modifier for modification of water is applicable for modification or cooling of water used in an industrial machine and equipment such as a pump, a motor or the like, or for modification or cooling of water used in an electric appliance such as an air conditioner, a computer or the like.

In addition to the purposes of improving the fuel consumption and cooling, it is possible to employ the present invention in various fields such as drinking water as in the Embodiment 5.

### EXAMPLES

Now, the description will be made for examples of the present invention.

### Example 1

In this example, qualitative analysis and quantitative analysis were made for chemical analysis of the water modifier used in the above embodiments. For the comparison with general earthy substance, components were compared between Comparative Example 1 (earthy substance obtained from the soil of Shinjuku Park in Tokyo) and Comparative Example 2 (earthy substance obtained from the soil of Tama river bank in Tokyo).

(Qualitative Analysis)

Qualitative analysis was made by high-frequency inductively coupled plasma emission spectrometry (ICP). The result of the qualitative analysis for the water modifier of the above embodiments is shown as follows:

| Component | Weight Ratio (Wt. %) |
|---|---|
| Al | 5-20 |
| B | 0.05-0.5 |
| Ba | 0.01-0.1 |
| Ca | 0.5-3 |
| Fe | 1-5 |
| K | 0.5-3 |
| Mg | 0.1-1 |
| Mn | 0.01-0.1 |
| Na | 0.1-1 |
| Si | 20-50 |
| Ti | 0.05-0.5 |
| Zn | 0.005-0.05 |

Each of the elements, Ag, As, Au, Be, Bi, Cd, Ce, Co, Cr, Cs, Cu, Dy, Er, Eu, Ga, Gd, Ge, Hf, Hg, Ho, In, Ir, La, Li, Lu, Mo, Nb, Nd, Ni, Os, P, Pb, Pd, Pr, Rb, Re, Rh, Ru, Sb, Sc, Se, Sm, Sn, Ta, Th, Te, Th, Tl, Tm, U, V, W, Y, Yb and Zr was not detected. With respect to Pt, accurate analysis was not possible since a container of Pt was used for pre-treatment and therefore there was a possibility that Pt was attached to a sample.

The result of the qualitative analysis for the Comparative Example 1 is shown as follows:

| Component | Weight Ratio (Wt. %) |
|---|---|
| Al | 2-10 |
| Ba | 0.005-0.05 |
| Ca | 5-20 |
| Fe | 2-10 |
| K | 0.1-1 |
| Mg | 1-5 |
| Mn | 0.05-0.5 |
| Na | 0.1-1 |
| Si | 5-20 |
| Ti | 0.1-1 |
| V | 0.005-0.05 |
| Zn | 0.005-0.05 |

Each of the elements, Ag, As, Au, B, Be, Bi, Cd, Ce, Co, Cr, Cs, Cu, Dy, Er, Eu, Ga, Gd, Ge, Hf, Hg, Ho, In, Ir, La, Li, Lu, Mo, Nb, Nd, Ni, Os, P, Pb, Pd, Pr, Rb, Re, Rh, Ru, Sb, Sc, Se, Sm, Sn, Ta, Tb, Te, Th, Tl, Tm, U, W, Y, Yb and Zr was not detected. With respect to Pt, accurate analysis was not possible since a container of Pt was used for pre-treatment and therefore there was a possibility that Pt was attached to a sample.

The result of the qualitative analysis for the Comparative Example 2 is shown as follows:

| Component | Weight Ratio (Wt. %) |
|---|---|
| Al | 2-10 |
| Ba | 0.01-0.1 |
| Ca | 0.5-3 |
| Fe | 2-10 |
| K | 0.5-3 |
| Mg | 0.5-3 |
| Mn | 0.05-0.5 |
| Na | 0.5-3 |
| Si | 20-50 |
| Ti | 0.1-1 |
| V | 0.005-0.05 |
| Zn | 0.005-0.05 |

Each of the elements, Ag, As, Au, B, Be, Bi, Cd, Ce, Co, Cr, Cs, Cu, Dy, Er, Eu, Ga, Gd, Ge, Hf, Hg, Ho, In, Ir, La, Li, Lu, Mo, Nb, Nd, Ni, Os, P, Pb, Pd, Pr, Rb, Re, Rh, Ru, Sb, Sc, Se, Sm, Sn, Ta, Tb, Te, Th, Tl, Tm, U, W, Y, Yb and Zr was not detected. With respect to Pt, accurate analysis was not possible since a container of Pt was used for pre-treatment and therefore there was a possibility that Pt was attached to a sample.

(Quantitative Analysis)

The quantitative analysis was made by combustion-infrared absorption method for C, mass spectrometry for Si, atomic absorption spectrometry for Na and K, and high-frequency inductively coupled plasma emission spectrometry (ICP) for other elements.

The result of the qualitative analysis for water modifier of the above embodiments is shown as follows:

| Component | Weight Ratio (Wt. %) |
|---|---|
| Al | 9.88 |
| B | 0.07 |
| Ba | 0.05 |
| Ca | 0.94 |
| Fe | 2.48 |
| K | 1.83 |
| Mg | 0.34 |
| Mn | 0.04 |
| Na | 0.85 |
| Si | 32.5 |
| Ti | 0.31 |
| Zn | 0.02 |
| C | 0.23 |

The above water modifier is made by firing earthy substance, in which metal oxides or metal compounds other than metal oxides, or various compounds such as compounds of elements other than metal element are contained as inorganic components of earthy substance. However, for carrying out the qualitative analysis and the quantitative analysis, solid is generally molten into solution state and analyzed under high temperature condition. Therefore, of the elements constituting a compound, oxygen or any other elements which mainly form negative ions are dispersed and therefore are not detected, so that only the metal elements or other elements which mainly form positive ions, or carbon which constitutes an inorganic compound are detected. On the other hand, although various compounds exist as inorganic components which constitute earthy substance, the content of each element detected by the qualitative analysis, the quantitative analysis and the like is expressed in terms of oxide by a conventional method, since those various compounds are generally oxidized when fired in air and it is convenient for intercomparison.

The quantitative values of each of the above components expressed in terms of oxide are as follows:

| Component | Weight Ratio (Wt. %) |
|---|---|
| Al₂O₃ | 18.7 |
| B₂O₃ | 0.23 |
| BaO | 0.06 |
| CaO | 1.32 |
| Fe₂O₃ | 3.55 |
| K₂O | 2.21 |
| MgO | 0.56 |
| MnO | 0.05 |
| Na₂O | 1.14 |
| SiO₂ | 69.6 |
| TiO₂ | 0.52 |
| ZnO | 0.02 |

Then, the quantitative analysis was made by the same testing method for the Comparative Example 1. The result of the quantitative analysis is as follows:

| Component | Weight Ratio (Wt. %) |
|---|---|
| Al | 7.00 |
| Ba | 0.02 |
| Ca | 9.52 |
| Fe | 4.76 |
| K | 0.60 |
| Mg | 2.39 |
| Mn | 0.10 |
| Na | 0.61 |
| Si | 18.0 |
| Ti | 0.38 |
| V | 0.02 |
| Zn | 0.02 |
| C | 5.39 |

The quantitative values of each of the above components expressed in terms of oxide based on the result of the quantitative analysis are as follows:

| Component | Weight Ratio (Wt. %) |
|---|---|
| Al₂O₃ | 13.2 |
| BaO | 0.02 |
| CaO | 13.3 |
| Fe₂O₃ | 6.81 |
| K₂O | 0.72 |
| MgO | 3.97 |
| MnO | 0.13 |
| Na₂O | 0.89 |
| SiO₂ | 38.4 |
| TiO₂ | 0.63 |
| V₂O₃ | 0.04 |
| ZnO | 0.02 |

Further, the quantitative analysis was made by the same testing method for the Comparative Example 2. The result of the quantitative analysis is as follows:

| Component | Weight Ratio (Wt. %) |
|---|---|
| Al | 7.02 |
| Ba | 0.04 |
| Ca | 1.11 |
| Fe | 6.10 |
| K | 1.32 |
| Mg | 1.20 |
| Mn | 0.10 |
| Na | 1.22 |
| Si | 30.6 |
| Ti | 0.42 |
| V | 0.02 |
| Zn | 0.02 |
| C | 0.97 |

The quantitative values of each of the above components expressed in terms of oxide based on the result of the quantitative analysis are as follows:

| Component | Weight Ratio (Wt. %) |
|---|---|
| Al₂O₃ | 13.3 |
| BaO | 0.04 |
| CaO | 1.56 |
| Fe₂O₃ | 7.29 |
| K₂O | 1.59 |
| MgO | 1.99 |
| MnO | 0.13 |
| Na₂O | 1.64 |
| SiO₂ | 65.5 |
| TiO₂ | 0.70 |
| V₂O₃ | 0.04 |
| ZnO | 0.02 |

As is apparent from the results of the qualitative analysis and the quantitative analysis, while Ba was detected in this example and therefore it was confirmed that a compound which contains Ba such as BaO as a component constituting water modifier of this example was contained, Ba was not detected in the Comparative Examples 1 and 2 and therefore it was confirmed that a compound which contains Ba such as BaO was not contained. On the other hand, while V was detected in the Comparative Examples 1 and 2 and therefore it was confirmed that a compound which contains V such as V₂O₃ was contained, V was not detected in this example and therefore it was confirmed that a compound which contains V such as V₂O₃ was not contained. Based on this result, the earthy substance that constitutes the water modifier of this example has a composition apparently different from the earthy substance of each of the Comparative Examples 1 and 2.

### Example 2

In this Example, commercially available mineral water was used and modified by the water modifier of the Embodiment 1 to produce modified water. The infrared absorption spectrum of the modified water was measured and compared with the infrared absorption spectrum of unmodified mineral water.

(Testing Method)

As a measuring instrument, Herschel FT/IR-680Plus, a vacuum-type Fourier transform infrared spectrometer was used. The measuring was conducted under the following conditions.

ATR Method (ATR PRO400S: ZnSe Prism was used)

Number of accumulations: 30 times

Resolution: 4 cm⁻¹

Detector: MCT (IRT-30 Standard Mid-band)

Modified water was prepared in the following manner. First, two metal chips each having a small rectangular plate-like shape with water modifier embedded therein were prepared in the same manner as the Embodiment 2. The weight of the water modifier filled in the metal chips was 1.5 g. 500 ml of commercially available mineral water in a PET bottle was laid down on its side, resting on the two metal chips in a dark room, and left for about 60 hours. Thus, modified water was prepared. On the other hand, commercially available mineral water in a PET bottle, which was not modified by such water modifier, was prepared as a comparative example (unmodified water).

The infrared absorption spectra were measured first for the unmodified water and then for the modified water. The PET bottle filled with the modified water was laid on its side before the measurement and well agitated.

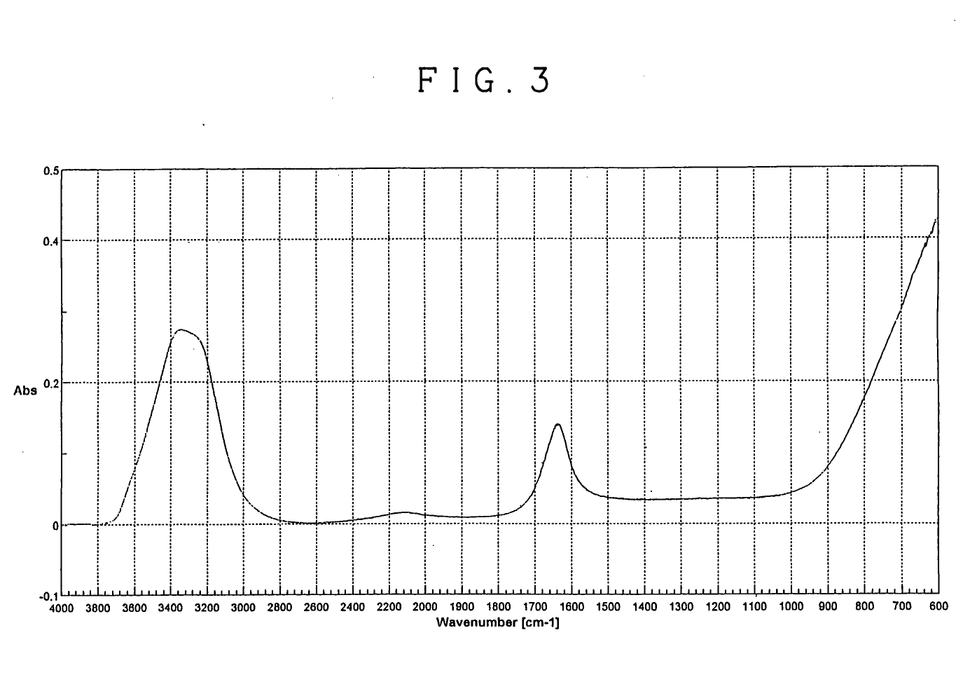

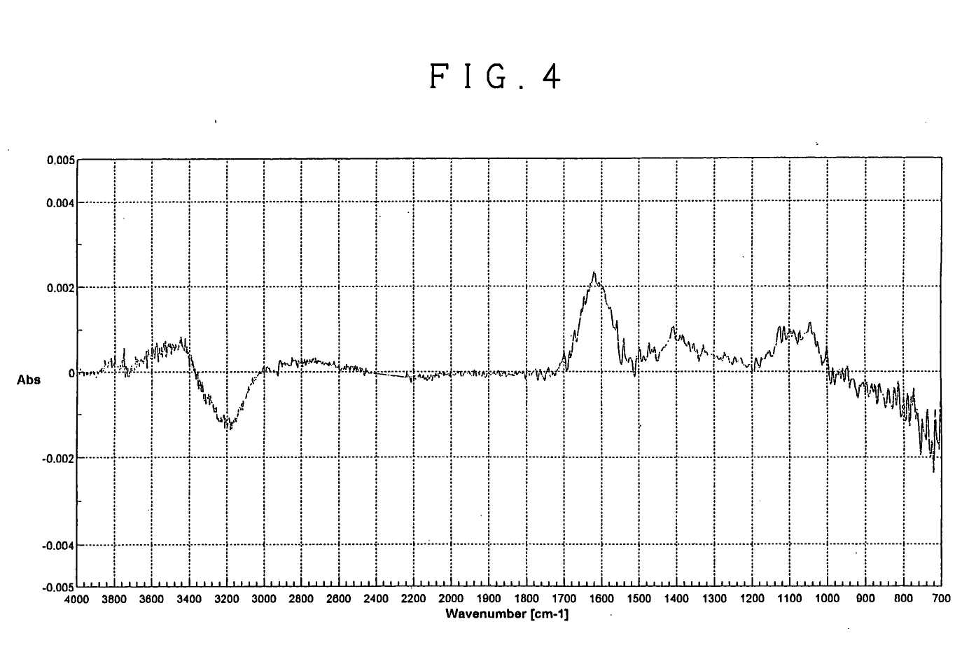

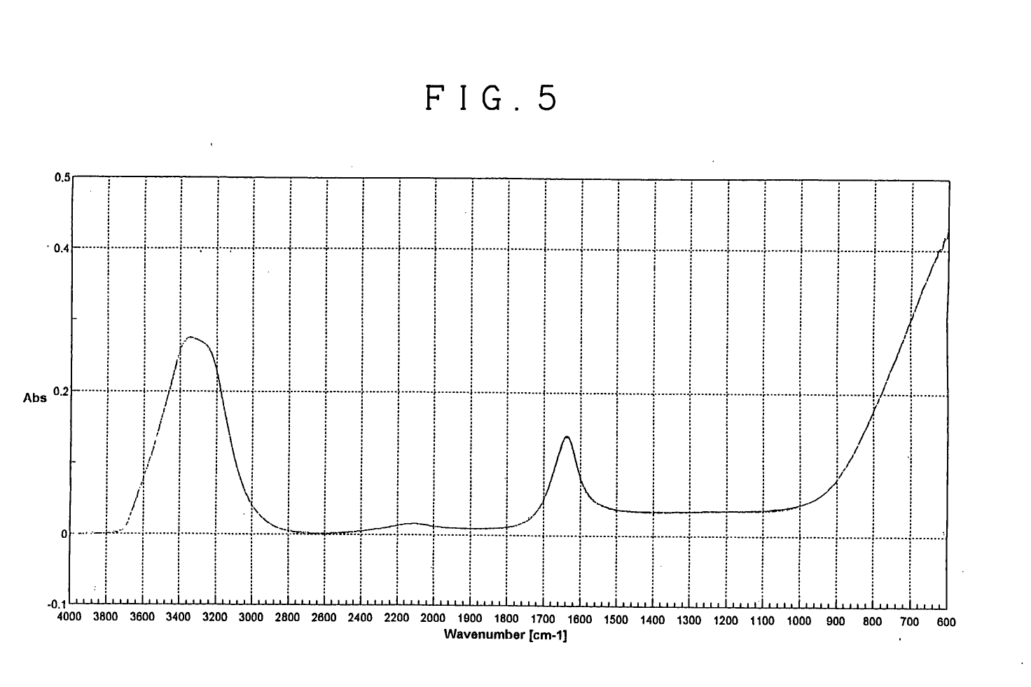

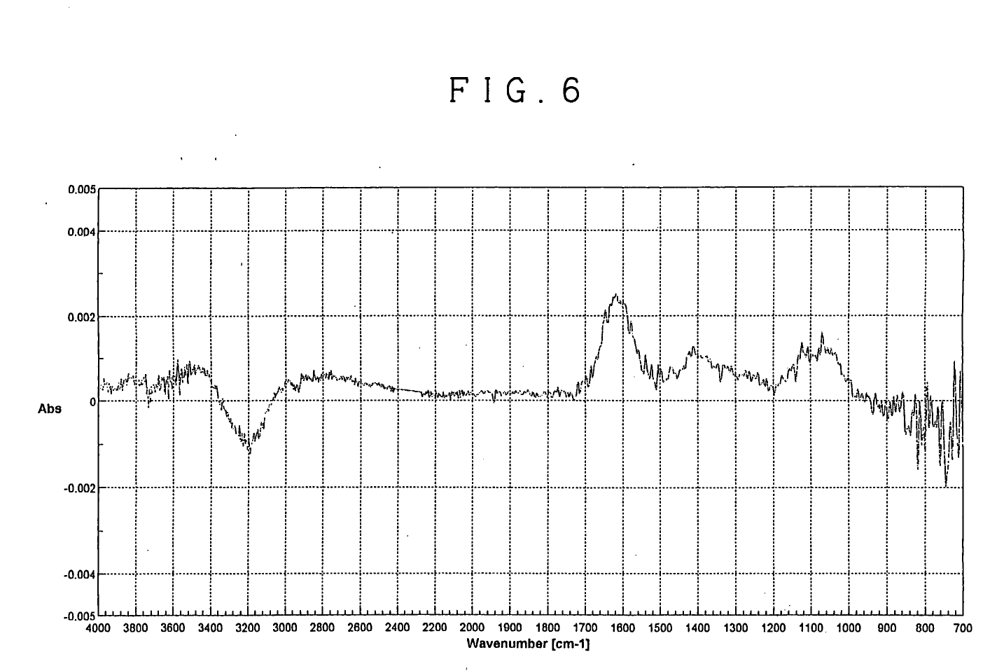

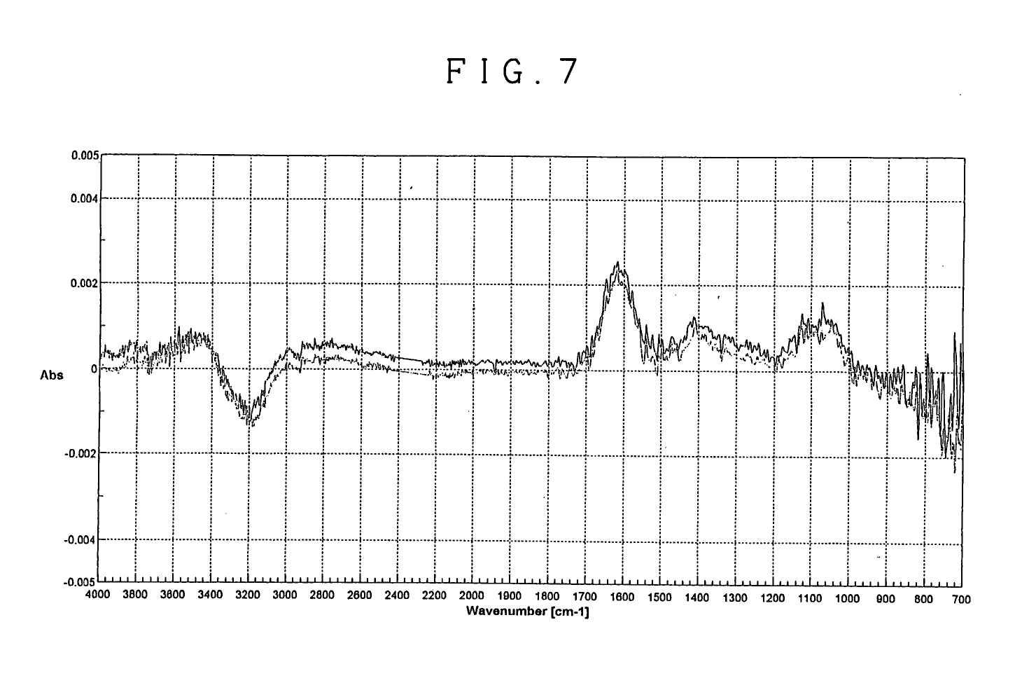

FIGS. 3-7 illustrate charts of the measured infrared absorption spectra. FIG. 3 illustrates overwritten infrared absorption spectra of the modified water and the unmodified water of the first measurement. FIG. 4 illustrates difference spectrum between the modified water and the unmodified water determined from FIG. 3. FIG. 5 illustrates overwritten infrared absorption spectra of the modified water and the unmodified water of the second measurement. FIG. 6 illustrates difference spectrum between the modified water and the unmodified water determined from FIG. 5. FIG. 7 illustrates difference spectra of FIGS. 4 and 6 overwritten each other.

As illustrated in FIG. 5, a peak of the absorption spectrum which is assumable as that resulting from OH stretching vibration of the water molecule appears between 3000-3600 cm⁻¹, and a peak of the absorption spectrum which is assumable as that resulting from H.O.H deformation vibration of the water molecule appears between 1600-1700 cm⁻¹. However, any apparent differences cannot be observed since the spectra of the modified water and the unmodified water are substantially overlapped each other in FIG. 5.

Accordingly, FIGS. 4 and 6, which illustrate the difference spectra, illustrate the spectral graphs exaggerated by enlarging the scale unit of the absorbance of the vertical axis. As a result, as illustrated in FIGS. 4 and 6, the intensity of the absorption spectrum of the modified water was relatively small and tendency of slight decrease in absorption spectrum was observed between 1600-1700 cm⁻¹ based on OH stretching vibration, while the intensity of the absorption spectrum of the modified water was relatively large and apparent tendency of increase in absorption spectrum was observed between 3000-3600 cm⁻¹ based on H.O.H deformation vibration.

As a whole, tendency of increase in absorption spectrum of the modified water was confirmed. The same result was obtained in the second measurement, as is apparent from the result of the overwritten difference spectra of FIG. 7, and reproducibility of the tendency of increase in absorption spectrum was confirmed.

According to the above test results, although there was a small change in spectrum, for water modified by the above water modifier, apparent change was confirmed in the range of 3000-3600 cm⁻¹ based on H.O.H deformation vibration, and this change is reproducible as appeared in FIG. 7. This means that molecules of modified water is more activated than those of unmodified water and apparent change is confirmed. It is therefore assumed that water modifier affected on commercially available mineral water and modified the same.

### Example 3

In this embodiment, commercially available mineral water was also used and modified by the water modifier of the Embodiment 1 to be used as modified water, whose terahertz absorption spectrum was measured and compared with the terahertz absorption spectrum of unmodified mineral water.

As a measuring instrument, RT-10000, a terahertz pulse spectroscopic instrument of Tochigi Nikon Corporation was used. The measuring was conducted under the following conditions.

Measured spectral range: 3.3-60 cm⁻¹ (0.1-1.8 THz)

Spectral resolution: ≦3.3 cm⁻¹ (≦0.1 THz)

Thickness of a sample: 0.1 mm

Modified water was prepared in the following manner. First, two metal chips each having a small rectangular plate-like shape with water modifier embedded therein were prepared in the same manner as the Embodiment 2. The weight of the water modifier embedded in the metal chips was 1.0 g. 500 ml of commercially available mineral water in a PET bottle was laid down on its side, resting on the two metal chips in a dark room, and left for about 100 hours. Thus, modified water was prepared. On the other hand, commercially available mineral water in a PET bottle, which was not modified by such water modifier, was prepared as a comparative example (unmodified water).

The terahertz absorption spectra were measured first for the unmodified water and then measured for the modified water. The PET bottle filled with the modified water was laid on its side before the measurement and well agitated, in the same manner as the Example 2.

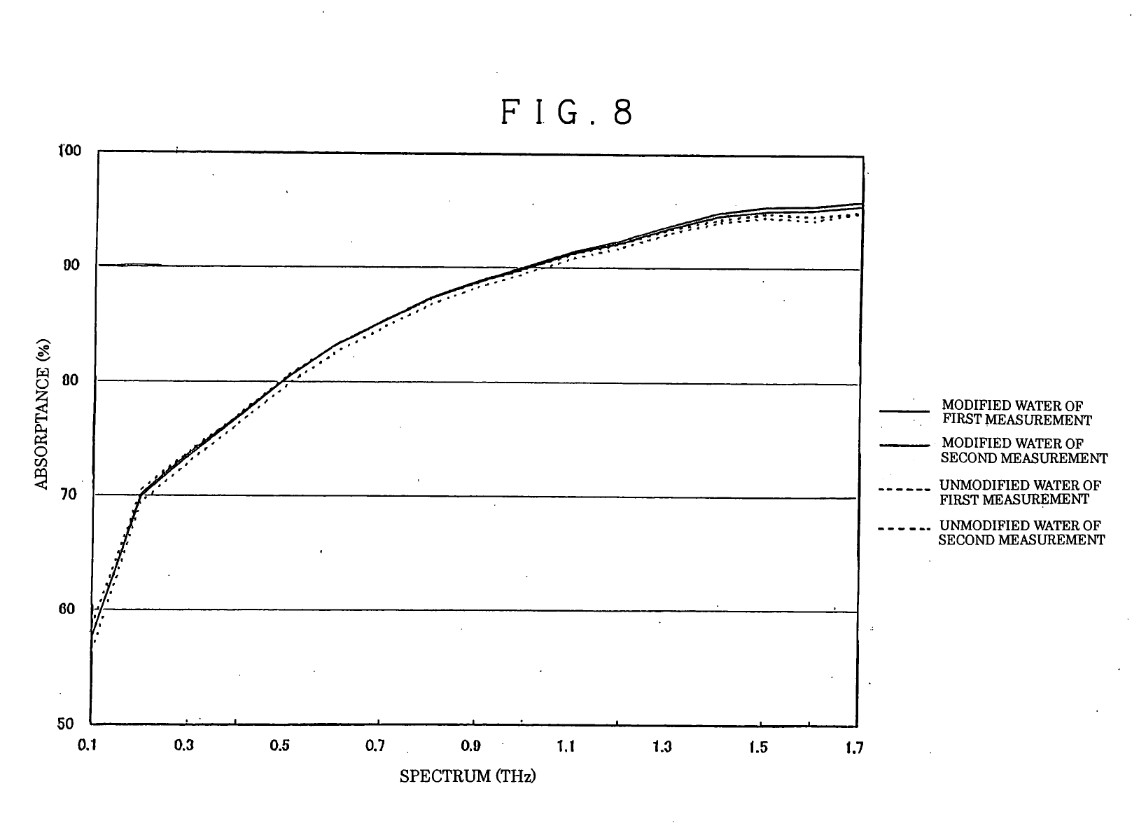

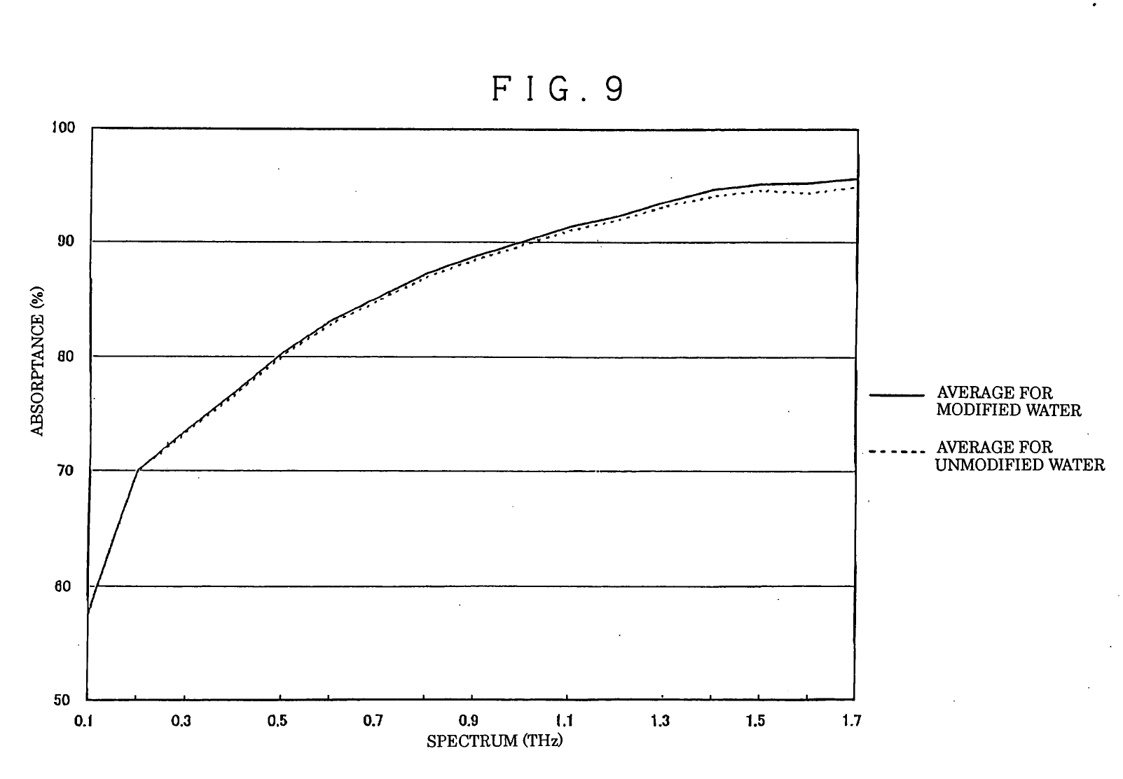

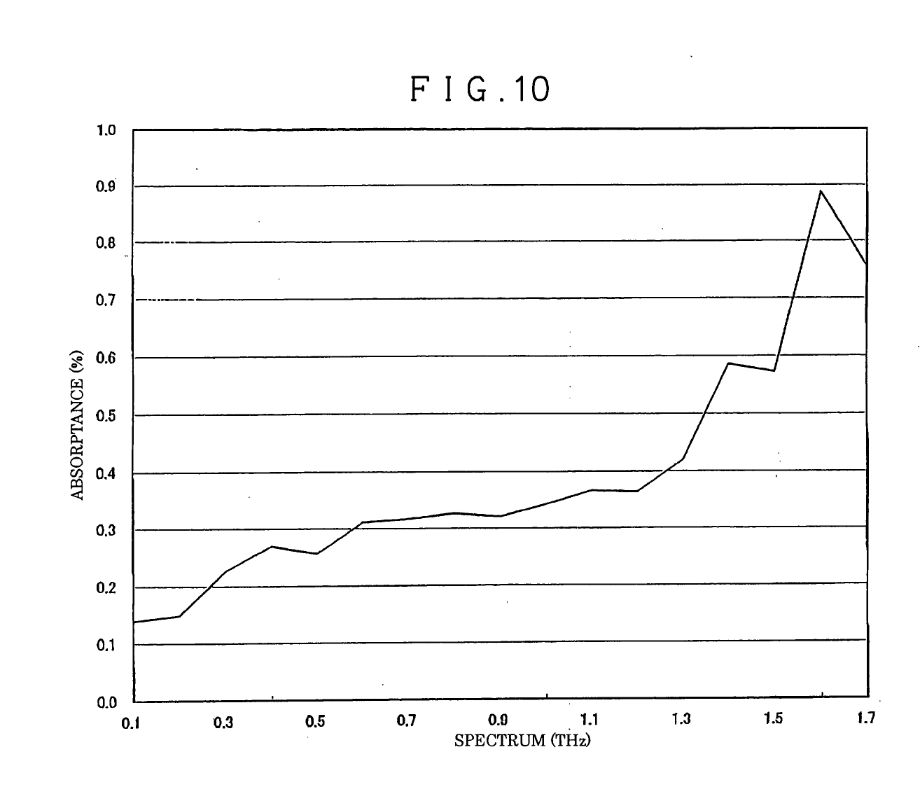

The terahertz absorption spectra as the measured results are illustrated in FIGS. 8-10. FIG. 8 illustrates the results of the measurements made twice for the terahertz absorption spectra of the unmodified water and the modified water; FIG. 9 illustrates the average absorption spectrum of the measurements made twice for each water; and FIG. 10 illustrates the differential spectrum between the modified water and the unmodified water determined from FIG. 9.

In FIGS. 8 and 9, the spectra of the modified water and the unmodified water are substantially overlapped each other with no substantial difference necessarily observed. Accordingly, FIG. 10 for the illustration of the difference spectrum illustrates a spectral graph exaggerated by enlarging the scale of unit of the absorbance of the vertical axis. As a result, as illustrated in FIG. 10, it was observed that as the frequency is increased, the absorptance is improved, that is, transmittance is decreased.

From the above results, it is confirmed that water is brought into a state where it has high energy disturbed so as to allow itself to easily absorb light than water before it is modified. It is therefore assumed from this that the water modifier affected on commercially available mineral water and modified the same.

### Example 4

In this embodiment, testing on the fuel consumption improvement of an automobile was conducted by using the water modifier of the Embodiment 1. Specifically, water modifier embedded in a metal chip as in the Embodiment 2 was prepared, and attached to an upper horse portion of a radiator. Under this condition, the automobile was driven. On the other hand, for comparison, the automobile was driven with no water modifier embedded in a metal chip attached thereto. Comparisons each were made for the same automobile, but testing was made by using various types of automobile. The test result is shown in Table 1.

TABLE 1

| | | | FUEL | FUEL | |
|---|---|---|---|---|---|
| | | | CONSUMPTION | CONSUMPTION | |
| | | | BEFORE | AFTER | |
| | DISPLACEMENT | | ATTACHMENT | ATTACHMENT | INCREASE |
| TYPE | (cc) | FUEL | (km/l) | (km/l) | RATE (%) |
| MERCEDES BENZ | 2600 | PREMIUM | 7.0 | 8.1 | 16 |
| OPELVITA | 1400 | PREMIUM | 8.3 | 9.0 | 8 |
| NISSAN ELGRAND | 3200 | PREMIUM | 7.0 | 8.1 | 16 |
| SAAB 900 | 2000 | PREMIUM | 6.5 | 7.2 | 11 |
| CADILLAC | 4500 | PREMIUM | 4.5 | 5.3 | 18 |
| OPELASTRA | 1800 | PREMIUM | 7.8 | 8.6 | 10 |
| HONDA STEPWAGON | 2000 | REGULAR | 8.0 | 9.8 | 23 |
| TOYOTA-PRADO | 3000 | PREMIUM | 6.0 | 7.7 | 28 |
| TOYOTA-CROWN | 4000 | PREMIUM | 5.5 | 6.3 | 15 |
| SUBARU-LEGACY | 2500 | PREMIUM | 7.8 | 10.1 | 29 |
| SUZUKI-WAGON R | 660 | REGULAR | 9.8 | 13.3 | 36 |
| HONDA INTEGRA | 1800 | REGULAR | 10.2 | 14.6 | 43 |
| NISSAN AVENIER | 2000 | REGULAR | 8.0 | 10.0 | 25 |
| TOYOTA TOWNACE | 2000 | REGULAR | 7.7 | 9.1 | 18 |
| NISSAN SERENA | 1800 | PREMIUM | 9.4 | 10.9 | 16 |
| TOYOTA ESTIMA | 2400 | PREMIUM | 3.4 | 4.9 | 44 |
| AVARAGE INCREASE RATE | | | | | 22.3 |

In Table 1, by fuel combustion before and after attachment are meant fuel consumption before and after attachment of the metal chip to a radiator. The increase rates are determined by subtracting the fuel consumption before the attachment from the fuel consumption after the attachment and expressed in percentage. As is apparent from Table 1, for most types of automobile, the fuel consumption was increased 10% or higher and an average of 20% or higher improvement could be confirmed.

### Example 5

In this example, evaluation was made on how drinking of water modified by water modifier in the above embodiments affects on the human body by measuring and determining change in impedance of the skin before and after the drinking.

Three types of sample, each are a metal chip with water modifier of the Embodiment 1 or the like embedded therein, were prepared with contents of the water modifier respectively being 0.5 g, 1.0 g and 1.5 g.

The measurement was made in the following manner. First, a glass of commercially available water was left on a metal chip with the water modifier embedded therein for about one hour, and the thus prepared water was drunk. The change in condition of the human body was investigated by measuring the condition of the body by using “Precarenady” (AMI-100, Skin impedance measuring instrument of Misawa (Medical Equipment Production Approval Number(04B)0768)) (hereinafter referred to AMI measurement).

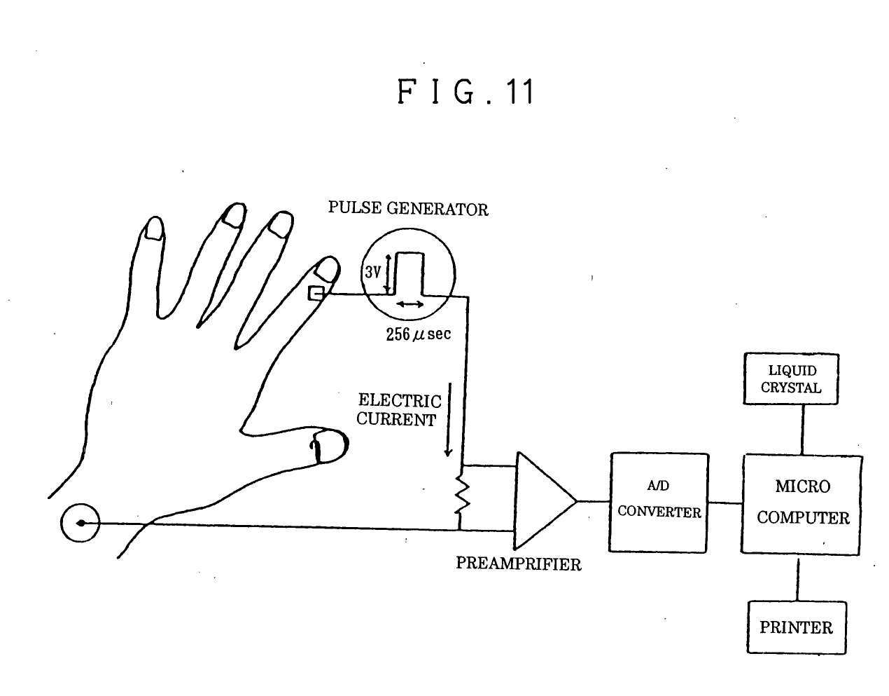

Specifically, 3 volts is applied to the skin of a part of the human body such as the skin of a hand by attaching electrodes thereto, as illustrated in FIG. 11 for only a short time (256 μsec), and the electric current flowing between the electrodes was measured and the reaction of the human body was evaluated by the following three parameters.

BP Average: Parameter on biological fluid circulation and vital energy flow

IQ Average: Parameter on biological defense function-immune strength, of the human body

AP Average: Parameter on autonomic nerves

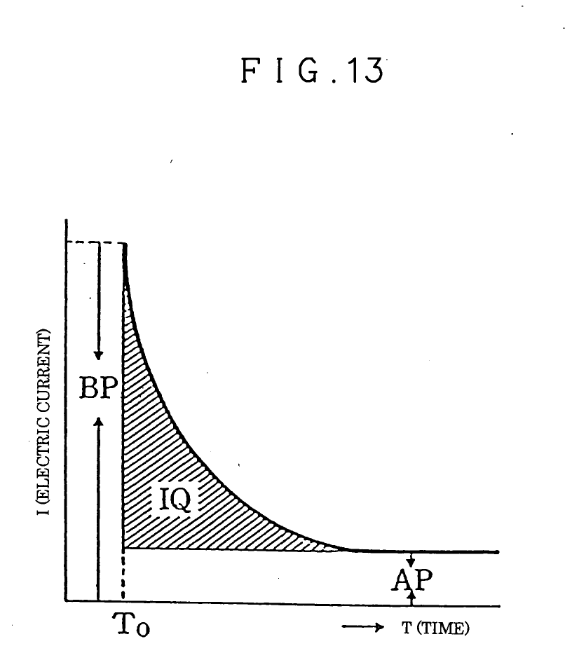

Herein, the description will be made for the principle of the AMI measurement. The skin is made up of the epidermis and the dermis, and the epidermis is further made up of stratum corneum, stratum lucidum, stratum granulosum, stratum basale and the like, in which electric current is hard to flow in the stratum lucidum and the stratum basale and is assumable that they act as electrically insulating layers. On the other hand, electric current is easy to flow between the stratum lucidum and the stratum basale, in the dermis and the like, and therefore electric charge is accumulated above and below each of the stratum lucidum and the stratum basale, that is, polarization occurs. When electric stimulus is applied to the human body, the human body first cannot fully deal with such abrupt change and therefore allows a relatively large electric current to flow inside of the dermis of the skin. However, the human body reacts thereto after a while and allows ions to be collected above and below of the dermis (basal lamina) and hence polarization to occur. As this polarization proceeds, the magnitude of electric current gradually decreases, and finally reaches a given level. However, it does not decrease to 0. This state is illustrated in FIG. 13.

Rectangular wave voltages applied to the human body are comprised of voltages having various frequency components based on the principle of Fourier series transform. Meanwhile, ions within the human body can catch up with only alternative voltage of 20 kHz or below due to limited ion speed. Therefore, in a part comprised of a very high-speed alternating portion that is a very beginning portion of a rectangular wave voltage, ions within the human body cannot catch up with it and therefore electric current flows inside of the dermis at this moment. It is a matter of course that this biophenomena is phenomena that occur for a very short time and at high speed as compared with other reactions that transmit through nerves.

Electric current that flows through the human body with a rectangular wave voltage applied thereto finally reaches a certain level after the decay of electric current as the time lapses. The electric currents before and after the decay are different from each other in magnitude and site through which the electric current flows. In the above measuring instrument, these two types of electric current and the sum of electric currents (electric charges) that have flown before the decay are designated as parameters that represent the status of the human body.

The BP (Before Polarization) represents the magnitude of electric current that flows before the vertical polarization (reverse current) occurs within the stratum basale (barrier stratum) of the inside of the epidermis by a rectangular wave voltage. The magnitude of the BP depends on the resistance inherent to the skin structure of the human body. A healthy trial subject with good biological fluid circulation allows electric current to easily flow therein (with less resistance), and a BP value to be increased. On the other hand, an elder or infirm person as a trial subject has poor biological fluid circulation and a decreased BP value.

The AP (After Polarization) represents the magnitude of electric current that flows after the vertical polarization occurs within the stratum basale (barrier stratum) of the inside of the epidermis. Even after the polarization is ended and no electric current flows inside of the epidermis, electric current, a magnitude of which is about 1/30- 1/40 of BP, continues to flow. It is assumed that most part of this electric current flows inside of the epidermis. From the clinical point of view, AP is considered as a parameter as to the status of the autonomic nerves, such as GSR (Galvanic Skin Response).

The IQ (Integrated Electrical Charge) represents the sum of ions gathered above and below of the barrier stratum (stratum basale), that is, the magnitude of the polarization. It is known that a patient or infirm person as a trial subject has an IQ smaller than a healthy person, and a person in an initial stage of disease or allergic person as a trial subject has an increased IQ. From the clinical point of view, IQ is considered as a parameter as to the defense function. The numerical meanings of BP, AP and IQ are represented in the graph of FIG. 13.

The AMI measurements were conducted for the total of three trial subjects, one male (age 52) and two females (ages 51 and 79). Three types of modified water (modified water 1, 2 and 3) were prepared by processing commercially available mineral water by three different metal chips respectively carrying the water modifier in different amounts and they each drank a cup of each of three types of the modified water (about 200 ml), and measurements were made after the elapse of 10 minutes.

The result of the test conducted on a trial subject 1 (male age 52) is shown in Table 2. As is apparent from Table 2, his BV average (μA) was greatly increased after 10 minutes since drinking of the modified water 1 modified by a metal chip with 0.5 g of the water modifier embedded therein; slightly increased after 10 minutes since drinking of the modified water 2 modified by a metal chip with 1.0 g of the water modifier embedded therein; and further increased after 10 minutes since drinking of the modified water 3 modified by a metal chip with 1.5 g of the water modifier embedded therein. On the other hand, his BV average was greatly decreased after 10 minutes since drinking of unmodified mineral water (unmodified water). Almost the same tendency was observed for the IQ average.

TABLE 2

| | | AFTER 10 | AFTER 10 | AFTER 10 | AFTER 10 |
|---|---|---|---|---|---|
| | | MINUTES SINCE | MINUTES SINCE | MINUTES SINCE | MINUTES SINCE |
| | | DRINKING OF | DRINKING OF | DRINKING OF | DRINKING OF |
| | BEFORE | MODIFIED | MODIFIED | MODIFIED | UNMODIFIED |
| | DRINKING | WATER 1 | WATER 2 | WATER 3 | WATER |
| BP AVERAGE | 1866 | 1906 | 1928 | 2013 | 1745 |
| IQ AVERAGE | 1550 | 1630 | 1617 | 1663 | 1427 |
| AP AVERAGE | 23 | 22 | 22 | 23 | 20 |

The result of the test conducted on a trial subject 2 (female age 51) is shown in Table 3. As is apparent from Table 3, her BV average was greatly increased after 10 minutes since drinking of the modified water 1 modified by a metal chip with 0.5 g of the water modifier embedded therein; still greatly increased after 10 minutes since drinking of the modified water 2 modified by a metal chip with 1.0 g of the water modifier embedded therein; and further increased after 10 minutes since drinking of the modified water 3 modified by a metal chip with 1.5 g of the water modifier embedded therein. On the other hand, his BP average was slightly decreased after 10 minutes since drinking of unmodified water. Almost the same tendency was observed for the IQ average.

TABLE 3

| | | AFTER 10 | AFTER 10 | AFTER 10 | AFTER 10 |
|---|---|---|---|---|---|
| | | MINUTES SINCE | MINUTES SINCE | MINUTES SINCE | MINUTES SINCE |
| | | DRINKING OF | DRINKING OF | DRINKING OF | DRINKING OF |
| | BEFORE | MODIFIED | MODIFIED | MODIFIED | UNMODIFIED |
| | DRINKING | WATER 1 | WATER 2 | WATER 3 | WATER |
| BP AVERAGE | 1764 | 1882 | 2073 | 2139 | 2062 |
| IQ AVERAGE | 1623 | 1888 | 2054 | 2168 | 1992 |
| AP AVERAGE | 17 | 20 | 18 | 23 | 21 |

The result of the test conducted on a trial subject 3 (female age 79) is shown in Table 4. As is apparent from Table 4, her BV average value was greatly increased after 10 minutes since drinking of the modified water 1 modified by a metal chip with 0.5 g of the water modifier embedded therein; almost not changed after 10 minutes since drinking of the modified water 2 modified by a metal chip with 1.0 g of the water modifier embedded therein; and greatly increased after 10 minutes since drinking of the modified water 3 modified by a metal chip with 1.5 g of the water modifier embedded therein. On the other hand, his BP average was slightly decreased after 10 minutes since drinking of unmodified water. Almost the same tendency was observed for the IQ average.

TABLE 4

| | | AFTER 10 | AFTER 10 | AFTER 10 | AFTER 10 |
|---|---|---|---|---|---|
| | | MINUTES SINCE | MINUTES SINCE | MINUTES SINCE | MINUTES SINCE |
| | | DRINKING OF | DRINKING OF | DRINKING OF | DRINKING OF |
| | BEFORE | MODIFIED | MODIFIED | MODIFIED | UNMODIFIED |
| | DRINKING | WATER 1 | WATER 2 | WATER 3 | WATER |
| BP AVERAGE | 1714 | 1826 | 1846 | 1905 | 1839 |
| IQ AVERAGE | 1177 | 1330 | 1347 | 1416 | 1326 |
| AP AVERAGE | 5 | 6 | 4 | 5 | 3 |

Along with the drinking of water modified by any of the water modifiers, the BV average representative of biological fluid circulation and vital energy flow, and the IQ average representative of biological defense function showed upward tendency. From this result, it was confirmed that modified water facilitates biological fluid circulation and improves vital energy flow, and further enhances biological defense function. On the other hand, no such effects were confirmed for unmodified water. It was confirmed that ass the amount of water modifier embedded in a metal chip increases, the effects thereof are enhanced. On the other hand, with respect to the AP average (μA), a great change was not observed between modified water and unmodified water.

### INDUSTRIAL APPLICABILITY

Water modifier of the present invention can be broadly applied for such as fuel consumption improvement of an automobile, giving a good function to the human body and other purposes.

1-9. (canceled)

10. A water modifier comprising fired earthy substance that contains at least one of Al₂O₃, B₂O₃, BaO, CaO, Fe₂O₃, K₂O, MgO, MnO, Na₂O, SiO₂, TiO₂ and ZnO.

11. Modified water obtained by treating water with the water modifier of claim 10.

12. Modified water obtained by making water through the water modifier of claim 10.

13. A coolant obtained by mixing the modified water of claim 11 with antifreeze.

14. The coolant according to claim 13, wherein the coolant contains 1-50% of the modified water and 50-99% of the antifreeze.

15. A coolant obtained by mixing the modified water of claim 12 with antifreeze.

16. The coolant according to claim 15, wherein the coolant contains 1-50% of the modified water and 50-99% of the antifreeze.

17. A method of producing a coolant comprising mixing the modified water of claim 11 with antifreeze.

18. The method of producing a coolant according to claim 17, wherein the modified water of claim 11 is mixed with antifreeze to form a mixture, and then the mixture is allowed to flow again through the water modifier of claim 10.

19. A method of producing a coolant comprising mixing the modified water of claim 12 with antifreeze.

20. The method of producing a coolant according to claim 10, wherein the modified water of claim 12 is mixed with antifreeze to form a mixture and then the mixture is allowed to flow again through the water modifier of claim 10.

21. A water modifier comprising an earthy substance that contains aluminium, boron, barium, calcium, iron, kalium, magnesium, manganese, sodium, silicon, titanium or zinc, or a compound containing these elements in an unfired state, and that contains at least one of Al₂O₃, B₂O₃, BaO, CaO, Fe₂O₃, K₂O, MgO, MnO, Na₂O, SiO₂, TiO₂ and ZnO in a fired state.

22. A water modifier comprising a fired earthy substance that contains 5-20 wt. % of aluminium, 0.05-0.5 wt. % of boron, 0.01-0.1 wt. % of barium, 0.5-3 wt. % of calcium, 1-5 wt. % of iron, 0.5-3 wt. % of kalium, 0.1-1 wt. % of magnesium, 0.01-0.1 wt. % of manganese, 0.1-1 wt. % of sodium, 20-50 wt. % of silicon, 0.05-0.5 wt. % of titanium, and 0.005-0.05 wt. % of zinc according to quantitative analysis by high-frequency inductively coupled plasma emission spectrometry (ICP).
